(19) United States
(12) Patent Application Publication
(10) Pub. No.: US 2014/0050098 A1
(43) Pub. Date: Feb. 20, 2014

(54) HANDLING SESSION LINKING STATUS IN GXX UPDATE

(71) Applicants: Ivy Mao, Kanata (CA); Matthew Yee, Kanata (CA); Xiaoyin Chen, Kanata (CA)

(72) Inventors: Ivy Mao, Kanata (CA); Matthew Yee, Kanata (CA); Xiaoyin Chen, Kanata (CA)

(73) Assignee: Alcatel-Lucent Canada, Inc., Ottawa (CA)

(21) Appl. No.: 13/585,387

(22) Filed: Aug. 14, 2012

(51) Int. Cl. H04L 12/26

(52) U.S. Cl. 370/241

(57) ABSTRACT

Various exemplary embodiments relate to a method of linking sessions at a Policy and Rules Charging Node (PCRN). The method may include: receiving a gateway control session establishment request from a first gateway, the establishment request indicating a first session linking status; establishing a gateway control session between the gateway and the PCRN; receiving a second message from the first gateway for the established gateway control session including a Session-Linking-Indicator AVP indicating a second session linking status; determining whether the PCRN has linked the gateway control session to an IP-CAN session; if the PCRN has not linked the gateway control session to an IP-CAN session, replacing the first session linking status with the second session linking status for the established gateway control session; and linking the gateway control session with an IP-CAN session according to the second session linking status.

### TECHNICAL FIELD

Various exemplary embodiments disclosed herein relate generally to telecommunications networks.

### BACKGROUND

As the demand increases for varying types of applications within mobile telecommunications networks, service providers must constantly upgrade their systems in order to reliably provide this expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks, leading to a less-than-elegant solution. As seen in second and third generation networks, voice services must be carried over dedicated voice channels and directed toward a circuit-switched core, while other service communications are transmitted according to the Internet Protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “Long Term Evolution” (LTE). In an LTE network, all communications are carried over an IP channel from user equipment (UE) to an all-IP core called the Evolved Packet Core (EPC). The EPC then provides gateway access to other networks while ensuring an acceptable QoE and charging a subscriber for their particular network activity.

The 3GPP generally describes the components of the EPC and their interactions with each other in a number of technical specifications that describe the Policy and Charging Rules Function (PCRF), Policy and Charging Enforcement Function (PCEF), and Bearer Binding and Event Reporting Function (BBERF) of the EPC. These specifications further provide some guidance as to how these elements interact in order to provide reliable data services and charge subscribers for use thereof.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of exemplary embodiments adequate to allow those of ordinary skill in the art to make and use the inventive concepts will follow in later sections.

Various exemplary embodiments relate to a method of linking sessions at a Policy and Rules Charging Node (PCRN). The method may include: receiving from a first gateway a first message that is a gateway control session establishment request, the establishment request indicating a first session linking status; establishing a gateway control session with the first session linking status between the gateway and the PCRN; receiving a second message from the first gateway for the established gateway control session indicating a second session linking status; determining whether the PCRN has linked the gateway control session to an IP-CAN session; if the PCRN has not linked the gateway control session to an IP-CAN session, replacing the first session linking status with the second session linking status for the established gateway control session; and linking the gateway control session with an IP-CAN session according to the second session linking status.

In various alternative embodiments, the method further includes receiving an IP-CAN session establishment request from a second gateway that matches the gateway control session; establishing an IP-CAN session between the PCRN and the second gateway; and immediately linking the IP-CAN session with the gateway control session.

In various alternative embodiments, the second session linking status indicates immediate linking and the step of linking the gateway control session with an IP-CAN session according to the second session linking status comprises immediately linking the gateway control session to an existing IP-CAN session.

In various alternative embodiments, the first session linking status indicates deferred linking and the method further includes waiting for a message from a second gateway or a second message from the first gateway before linking the gateway control session.

In various alternative embodiments, the second session linking status indicates deferred linking and the step of linking the gateway control session with an IP-CAN session according to the second session linking status includes waiting for a message from the second gateway before linking the gateway control session with an IP-CAN session.

In various alternative embodiments, the method further includes determining that the gateway control session is already linked to an IP-CAN session; and generating a warning indicating an extraneous Session-Linking-Indicator AVP was received.

In various alternative embodiments, the second message from the first gateway is a credit control request (CCR) update message.

In various alternative embodiments, the first gateway is a serving gateway including a bearer binding and event reporting function.

In various alternative embodiments, the session linking status of a message is indicated by a default value of the Session-Linking-Indicator AVP.

Various exemplary embodiments relate to the above described method encoded on a non-transitory machine-readable storage medium as instructions executable by at least one processor for performing the above method.

It should be apparent that, in this manner, various exemplary embodiments enable handling session linking at a PCRN. In particular, by tracking a session linking status of a gateway control session, the PCRN may handle gateway control session update messages changing the session linking status.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services;

FIG. 2 illustrates a flowchart showing an exemplary method of handling session linking;

FIG. 3 illustrates a message diagram showing an exemplary scenario for handling a Session-Linking-Indicator AVP; and

FIG. 4 illustrates a message diagram showing another exemplary scenario for handling a Session-Linking-Indicator AVP.

### DETAILED DESCRIPTION

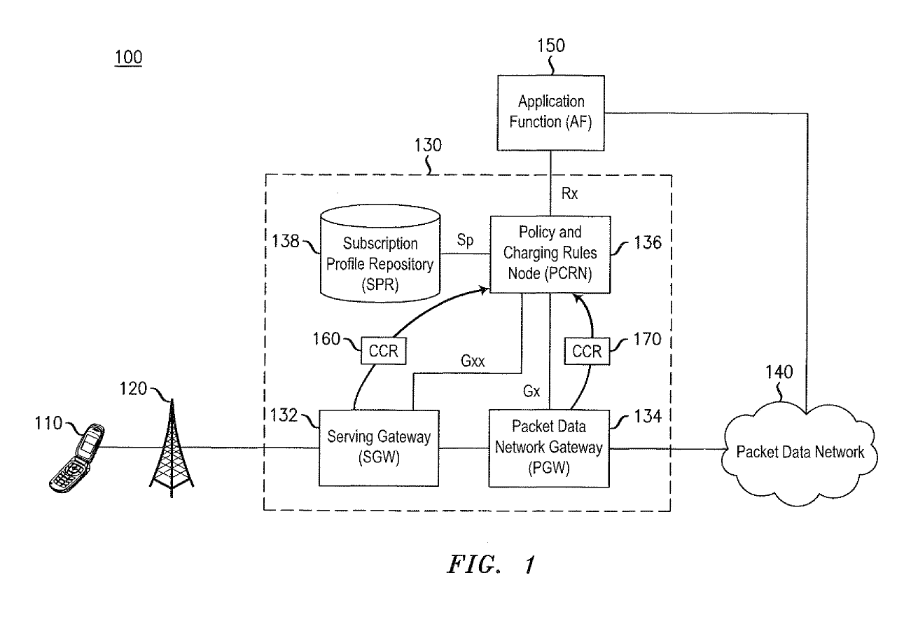

FIG. 1 illustrates an exemplary subscriber network 100 for providing various data services. Exemplary subscriber network 100 may be a telecommunications network or other network for providing access to various services. Exemplary subscriber network 100 may include user equipment 110, base station 120, evolved packet core (EPC) 130, packet data network 140, and application function (AF) 150.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 may include a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the 3GPP standards. Accordingly, EPC 130 may include a serving gateway (SGW) 132, a packet data network gateway (PGW) 134, a policy and charging rules node (PCRN) 136, and a subscription profile repository (SPR) 138.

Serving gateway (SGW) 132 may be a device that provides gateway access to the EPC 130. SGW 132 may be the first device within the EPC 130 that receives packets sent by user equipment 110. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP (PMIP) standard, SGW 132 may include a Bearer Binding and Event Reporting Function (BBERF). SGW 132 may communicate with PCRN 136 by establishing a gateway control session over the Gxx reference point. In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Policy and charging rules node (PCRN) 136 may be a device or group of devices that manages services for a user equipment. The PCRF may provide network control regarding service data flows, Quality of Service (QoS), and charging. PCRN 136 may receive requests for application services, generate PCC and/or QoS rules, provide PCC rules to a PGW 134, and provide QoS rules to SGW 132. PCRN 136 may be in communication with various network nodes and receive numerous messages from the network nodes. PCRN 136 may process the received messages according to network policies and send responses to manage network services.

PCRN 136 may be in communication with SGW 132 and PGW 134 via a Gxx and a Gx interface, respectively. PCRN 136 may establish a gateway control session with SGW 132 via a Gxx interface. PCRN 136 may receive a Credit Control Request (CCR) 160 message from SGW 132 indicating an initial request for a gateway control session. The CCR 160 may include a subscriber identifier such as an international mobile subscriber identifier (IMSI) and an access network gateway address. The CCR 160 may also include information regarding the IP-CAN type, radio access type, and packet data network. The CCR 160 may include an indication of a session linking status. For example, the CCR 160 may include a Session-Linking-Indicator AVP. A Session-Linking-Indicator AVP may have a value of SESSION_LINKING_IMMEDIATE indicating immediate session linking or a value of SESSION_LINKING_DEFERRED indicating deferred session linking. The Session-Linking-Indicator AVP may also have a default value. For example, PCRN 136 may assign a default value of SESSION_LINKING_IMMEDIATE if the Session-Linking-Indicator AVP does not define a value or is absent from CCR 160. The term “immediate” or “immediately” as used herein, may refer to performing an action without intentional delay. An action may be performed immediately even if performance is delayed, for example, because of lack of system resources such as processor time or memory. The term “deferred” as used herein may refer to intentionally delaying an action. For example, an action may be deferred by waiting for a certain period of time or by waiting for a particular event.

PCRN 136 may establish an Internet Protocol Connectivity Access Network (IP-CAN) session with PGW 134 via a Gx interface. PCRN 136 may receive a CCR message 170 from PGW 134 indicating an initial request for an IP-CAN session. The CCR 170 may include a subscriber identifier. The CCR 170 may also include information regarding the IP-CAN type, radio access type, and packet data network.

Both a gateway control session and an IP-CAN session may relate to a single subscriber. In various exemplary embodiments, such as those implementing a PMIP standard, both a gateway control session and an IP-CAN session may be necessary to provide connectivity for user equipment 110. PCRN 136 may link a gateway control session and an IP-CAN session in order to maintain consistency in policies and rules for a subscriber's session. PCRN 136 may be able to link a gateway control session with an IP-CAN session only if both sessions have been established. In various exemplary embodiments, CCR 160 and CCR 170 may arrive in any order. Additionally, PCRN 136 may receive CCR update messages related to an established session that may arrive before or after a CCR message from the other gateway has arrived. Accordingly, PCRN 136 may process CCR messages arriving in any order. A session establishment message from SGW 132 may include a session linking status indicating whether PCRN 136 should immediately link the sessions or defer linking the sessions until PCRN 136 has received a new IP-CAN session establishment or update message. Such a deferred linking may prevent incorrect or pre-mature linking. PCRN 136 may receive an update message from SGW 132 indicating an update to the session linking status. PCRN 136 may update the session linking status if the sessions have not already been linked. For example, an SGW 132 may update the session linking status to immediately link the sessions rather than deferring. If session linking has already occurred when the update request is received, PCRN 136 may generate an error log indicating that an extraneous update request was received.

Upon creating a new PCC rule or upon request by the PGW 134, PCRN 136 may provide a PCC rule to PGW 134 via the Gx interface using a CCA message. PGW 134 may determine whether PGW 134 is able to install the PCC rule. For example, PGW 134 may determine whether it has sufficient resources to process the additional service data flow. PGW 134 may send PCRN 136 a RAA message indicating whether the rule was successfully installed. In various embodiments, such as those implementing the proxy mobile IP (PMIP) standard for example, PCRN 136 may also generate QoS rules. Upon creating a new QoS rule or upon request by the SGW 132, PCRN 136 may provide a QoS rule to SGW 132 via the Gxx interface. The PCC and QoS rules may be based on a linked gateway control session or IP-CAN session.

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136 or may constitute an independent node within EPC 130. Data stored by SPR 138 may include an identifier of each subscriber and indications of subscription information for each subscriber such as bandwidth limits, charging parameters, and subscriber priority.

Packet data network 140 may be any network for providing data communications between user equipment 110 and other devices connected to packet data network 140, such as AF 150. Packet data network 140 may further provide, for example, phone and/or Internet service to various user devices in communication with packet data network 140.

Application function (AF) 150 may be a device that provides a known application service to user equipment 110. Thus, AF 150 may be a server or other device that provides, for example, a video streaming or voice communication service to user equipment 110. AF 150 may further be in communication with the PCRN 136 of the EPC 130 via an Rx interface. When AF 150 is to begin providing known application service to user equipment 110, AF 150 may generate an application request message, such as an authentication and authorization request (AAR) according to the Diameter protocol, to notify the PCRN 136 that resources should be allocated for the application service. This application request message may include information such as an identification of the subscriber using the application service, an IP address of the subscriber, an APN for an associated IP-CAN session, and/or an identification of the particular service data flows that must be established in order to provide the requested service. AF 150 may communicate such an application request to the PCRN 136 via the Rx interface.

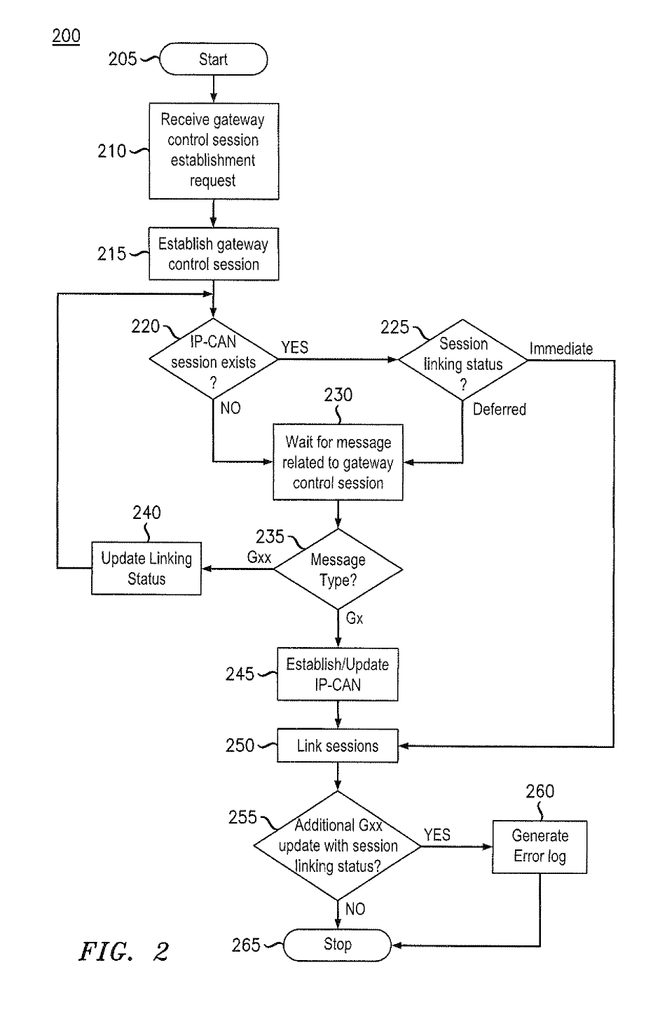

FIG. 2 illustrates a flowchart showing an exemplary method 200 of handling session linking. Method 200 may be performed by the various components of PCRN 136. Method 200 may begin at step 205 and proceed to step 210.

In step 210, PCRN 136 may receive a gateway control session establishment request. The gateway control session establishment request may be a credit control request (CCR) received via the Gxx interface from an SGW such as SGW 132. The gateway control session establishment request may include a Session-Linking-Indicator AVP that indicates a session linking status. In step 215, PCRN 136 may establish the requested gateway control session. PCRN 136 may select a session ID for the requested gateway control session and store information from the received session establishment request in association with the session ID. PCRN 136 may associate the session linking status of the Session-Linking-Indicator AVP with the new gateway control session ID. PCRN 136 may also make policy decisions for the new gateway control session by, for example, identifying subscriber information associated with the new session. The method 200 may then proceed to step 220.

In step 220, PCRN 136 may determine whether an IP-CAN session matching the new gateway control session exists. PCRN 136 may search a list of IP-CAN sessions for a session having a subscriber ID or other shared identifier matching the gateway control session. If a matching IP-CAN session exists, the method 200 may proceed to step 225. If there is no matching IP-CAN session, the method 200 may proceed to step 230.

In step 225, PCRN 136 may determine the session linking status of the gateway control session. If the session linking status of the gateway control session indicates deferred linking, the method 200 may proceed to step 230. If the session linking status of the gateway control session indicates immediate linking, the method 200 may proceed to step 250.

In step 230, PCRN 136 may wait to receive a message from a gateway such as SGW 132 or PGW 134. PCRN 136 may wait because it does not have enough information or has been instructed to defer session linking. The message may arrive from SGW 132 via the Gxx interface or from PGW 134 via the Gx interface. The message may be related to the established gateway control session because it includes a subscriber identifier matching the subscriber for the established gateway control session. If a received message is not related to the existing gateway control session, PCRN 136 may process the message separately according to the type of message. In step 235, PCRN 136 may determine which type of message related to the gateway control session has arrived has arrived. If PCRN 136 receives a message such as a CCR update message from SGW 132 via the Gxx interface updating the gateway control session, the method 200 may proceed to step 240. If PCRN 136 receives a message such as a CCR from PGW 134 via the Gx interface establishing or updating an IP-CAN session, the method 200 may proceed to step 245.

In step 240, PCRN 136 may update the session linking status associated with the gateway control session. PCRN 136 may extract a new session linking status from a Session-Linking-Indicator AVP of the received CCR update message. The method 200 may then return to step 220.

In step 245, PCRN 136 may process the received CCR message from PGW 134 in order to establish or update an IP-CAN session. PCRN 136 may extract information from the received CCR message and store the information in association with the IP-CAN session. The method 200 may then proceed to step 250.

In step 250, PCRN 136 may link the gateway control session and the IP-CAN session. Linking the two sessions may include storing the session identifiers together in a linking table or storing a reference to the linked session in one or both of the records for the sessions. Linking the sessions may help provide consistency. For example, when PCRN 136 generates a new PCC rule for the IP-CAN session, PCRN 136 may automatically generate a QoS rule for the gateway control session. Similarly, status information and event reports received for one session may also affect the linked session. Once the sessions are linked, the method 200 may proceed to step 255.

In step 255, PCRN 136 may determine whether it has received any additional CCR update message via the Gxx interface after the sessions have been linked. In particular, PCRN 136 may determine whether a received CCR update message includes a Session-Linking-Indicator AVP. PCRN 136 may ignore a session linking status indicated in a message that arrives after the sessions have been linked. If PCRN 136 has received an additional CCR update message indicating a session linking status, method 200 may proceed to step 260. If PCRN 136 receives no additional CCR update messages indicating a session linking status, the method 200 may proceed to step 265, where the method 100 ends.

In step 260, PCRN 136 may generate an error log related to the received additional CCR update message. PCRN 136 may add an entry to a log file indicating that an extraneous CCR update message indicating a session linking status arrived after the gateway control session was already linked to an IP-CAN session. PCRN 136 may also notify a network operator or other user of the network about the extraneous CCR update message using a simple network management protocol (SNMP), email, or any other communication means.

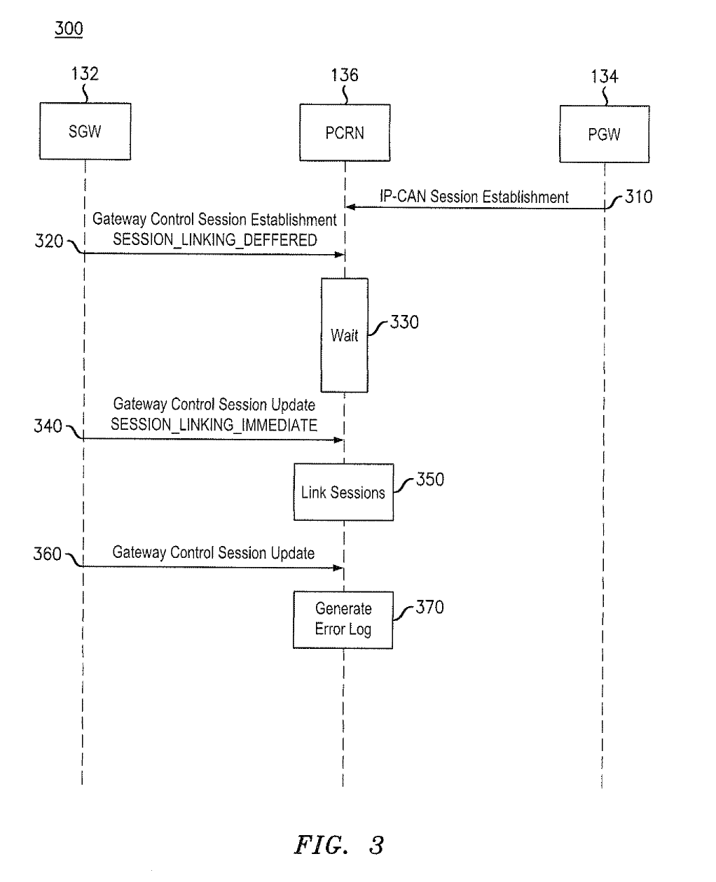

FIG. 3 illustrates a message diagram 300 showing an exemplary scenario for handling a Session-Linking-Indicator AVP. Message diagram 300 may illustrate messages sent between SGW 132, PCRN 136, and PGW 134. Horizontal arrows may illustrate a message. It should be apparent that an arrow may represent both a step of sending a message and a step of receiving a message.

In step 310, PCRN 136 may receive an IP-CAN session establishment request from PGW 134. The IP-CAN session establishment request may arrive before any messages are received from SGW 132 relating to a matching gateway control session. PCRN 136 may process the received IP-CAN session establishment request to establish an IP-CAN session. Accordingly, an IP-CAN session for a user equipment 110 may exist when additional messages are received.

In step 320, PCRN 136 may receive a gateway control session establishment request that matches the existing IP-CAN session. The gateway control session establishment request may indicate a session linking status of deferred. For example, a Session-Linking-Indicator AVP may include a value SESSION_LINKING_DEFERRED. PCRN 136 may process the received gateway control session establishment request to establish the gateway control session. However, PCRN 136 may defer linking the gateway control session to the existing IP-CAN session.

In step 330, PCRN 136 may wait to receive a message from PGW 134 updating the IP-CAN session. PCRN 136 may wait indefinitely for a message to arrive from PGW 134. Alternatively, PCRN 136 may wait for a set time period.

In step 340, PCRN 136 may receive a gateway control session update message for the established gateway control session. The update message may indicate a new session linking status. For example, the message may include a Session-Linking-Indicator AVP with a value of SESSION_LINKING_IMMEDIATE. In various embodiments, the update message may not include the Session-Linking-Indicator AVP, or no value may be defined for the Session-Linking-Indicator AVP. In such embodiments, a default value of SESSION_LINKING_IMMEDIATE may be used. Upon receipt of the update message, PCRN 136 may determine whether a matching IP-CAN session exists.

In step 350, PCRN 136 may immediately link the gateway control session to the existing IP-CAN session without waiting for a message from PGW 134. Accordingly, a CCR update message over the Gxx interface may be used by SGW 132 to attempt immediate linking of the sessions. For example, SGW 132 may include a deferred session linking status in the establishment request, then send an update message with the immediate session linking status. Such an approach may provide flexibility for a first gateway attempting to coordinate with a second gateway.

In step 360, PCRN 136 may receive another gateway control session update. This gateway control session update message may arrive after PCRN 136 has linked the gateway control session to an IP-CAN session. Accordingly, a new session linking status may have no effect on the linked sessions. In step 370, PCRN 136 may generate an error log for the message received after PCRN 136 has linked the sessions.

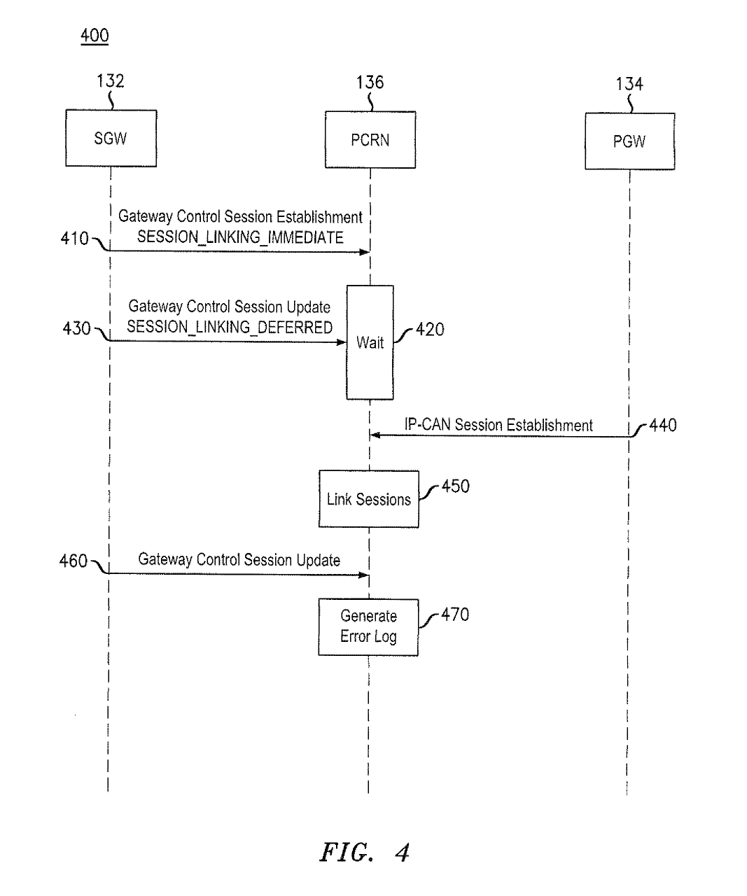

FIG. 4 illustrates a message diagram 400 showing another exemplary scenario for handling a Session-Linking-Indicator AVP. Message diagram 400 may illustrate messages sent between SGW 132, PCRN 136, and PGW 134. Horizontal arrows may illustrate a message. It should be apparent that an arrow may represent both a step of sending a message and a step of receiving a message.

In step 410, PCRN 136 may receive a gateway control session establishment request from SGW 132. The gateway control session establishment request may be in the form of a CCR message arriving via the Gxx interface. PCRN 136 may establish the gateway control session. PCRN 136 may determine the session linking status of the gateway control session according to a Session-Linking-Indicator AVP included in the session establishment request. For example, if the Session-Linking-Indicator AVP includes the value SESSION_LINKING_PCRN 136 may set the session linking status to immediate. However, the gateway control session establishment request may have arrived at PCRN 136 before an IP-CAN session establishment request. Accordingly, the gateway control session may not be able to link immediately to any IP-CAN session.

In step 420, PCRN 136 may wait to receive an IP-CAN session establishment request from PGW 134. PCRN 136 may wait indefinitely for the IP-CAN session establishment request to arrive. Alternatively, PCRN 136 may impose a time limit and terminate the gateway control session if the matching IP-CAN session establishment request does not arrive before the time limit expires.

In step 430, PCRN 136 may receive a gateway control session update message. The message may be in the form of a CCR update received via the Gxx interface. The message may indicate a new session linking status. For example, the message may include a Session-Linking-Indicator AVP with a value of SESSION_LINKING_DEFERRED. PCRN 136 may update the session linking status of the gateway control session to match the received session linking status. However, PCRN 136 may continue to wait for an IP-CAN session establishment message if there is no IP-CAN session matching the gateway control session. PCRN 136 may receive additional gateway control session update messages before it receives an IP-CAN session establishment request and process the received messages in a similar manner.

In step 440, PCRN 136 may receive an IP-CAN session establishment request. PCRN 136 may establish the IP-CAN session according to the establishment request. PCRN 136 may determine that the newly established IP-CAN session matches the existing gateway control session.

In step 450, PCRN 136 may link the existing gateway control session to the newly established IP-CAN session regardless of the session linking status. The session linking status may indicate linking should occur immediately, or it may indicate linking should be deferred until the IP-CAN session is updated. In either case, the arrival of the IP-CAN session establishment request may allow linking of the sessions.

In step 460, PCRN 136 may receive another gateway control session update. This gateway control session update message may arrive after PCRN 136 has linked the gateway control session to an IP-CAN session. Accordingly, a new session linking status may have no effect on the linked sessions. In step 470, PCRN 136 may generate an error log for the message received after PCRN 136 has linked the sessions.

According to the foregoing, various exemplary embodiments enable handling session linking at a PCRN. In particular, by tracking a session linking status of a gateway control session, the PCRN may handle gateway control session update messages changing the session linking status.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of linking sessions at a Policy and Rules Charging Node (PCRN), the method comprising:
receiving from a first gateway, a first message that is a gateway control session establishment request, the establishment request indicating a first session linking status;
establishing a gateway control session with the first session linking status between the gateway and the PCRN;
receiving a second message from the first gateway for the established gateway control session indicating a second session linking status;
determining whether the PCRN has linked the gateway control session to an IP-CAN session;
if the PCRN has not linked the gateway control session to an IP-CAN session, replacing the first session linking status with the second session linking status for the established gateway control session; and
linking the gateway control session with an IP-CAN session according to the second session linking status.

2. The method of claim 1, further comprising:
receiving an IP-CAN session establishment request from a second gateway that matches the gateway control session;
establishing an IP-CAN session between the PCRN and the second gateway; and
immediately linking the IP-CAN session with the gateway control session.

3. The method of claim 1, wherein the second session linking status indicates immediate linking and the step of linking the gateway control session with an IP-CAN session according to the second session linking status comprises immediately linking the gateway control session to an existing IP-CAN session.

4. The method of claim 1, wherein the first session linking status indicates deferred linking, the method further comprising waiting for a message from a second gateway or a second message from the first gateway before linking the gateway control session.

5. The method of claim 1, wherein the second session linking status indicates deferred linking and the step of linking the gateway control session with an IP-CAN session according to the second session linking status comprises waiting for a message from the second gateway before linking the gateway control session with an IP-CAN session.

6. The method of claim 1, further comprising:
determining that the gateway control session is already linked to an IP-CAN session;
generating a warning indicating an extraneous session linking status indicator was received.

7. The method of claim 1, wherein the second message from the first gateway is a credit control request (CCR) update message.

8. The method of claim 1, wherein the first gateway is a serving gateway including a bearer binding and event reporting function.

9. The method of claim 1, wherein the session linking status of a message is indicated by a value of a Session-Linking-Indicator AVP.

10. A non-transitory machine-readable storage medium encoded with instructions executable by a processor of a Policy and Rules Charging Node for linking sessions, the non-transitory machine-readable storage medium comprising:
instructions for receiving from a first gateway a first message that is a gateway control session establishment request, the establishment request indicating a first session linking status;
instructions for establishing a gateway control session with the first session linking status between the gateway and the PCRN;
instructions for receiving a second message from the first gateway for the established gateway control session including a Session-Linking-Indicator AVP indicating a second session linking status;
instructions for determining whether the PCRN has linked the gateway control session to an IP-CAN session;
instructions for replacing the first session linking status with the second session linking status for the established gateway control session if the PCRN has not linked the gateway control session to an IP-CAN session; and
instructions for linking the gateway control session with an IP-CAN session according to the second session linking status.

11. The non-transitory machine-readable storage medium of claim 10, further comprising:
instructions for receiving an IP-CAN session establishment request from a second gateway that matches the gateway control session;
instructions for establishing an IP-CAN session between the PCRN and the second gateway; and
instructions for immediately linking the IP-CAN session with the gateway control session.

12. The non-transitory machine-readable storage medium of claim 10, wherein the second session linking status indicates immediate linking and the instructions for linking the gateway control session with an IP-CAN session according to the second session linking status comprise instructions for immediately linking the gateway control session to an existing IP-CAN session.

13. The non-transitory machine-readable storage medium of claim 10, wherein the first session linking status indicates deferred linking, the non-transitory machine-readable storage medium further comprising instructions for waiting for a message from a second gateway or a second message from the first gateway before linking the gateway control session.

14. The non-transitory machine-readable storage medium of claim 10, wherein the second session linking status indicates deferred linking and the instructions for linking the gateway control session with an IP-CAN session according to the second session linking status comprise instructions for waiting for a message from the second gateway before linking the gateway control session with an IP-CAN session.

15. The non-transitory machine-readable storage medium of claim 10, further comprising:
instructions for determining that the gateway control session is already linked to an IP-CAN session; and
instructions for generating a warning indicating an extraneous Session-Linking-Indicator AVP was received.

16. The non-transitory machine-readable storage medium of claim 10, wherein the second message from the first gateway is a credit control request (CCR) update message.

17. The non-transitory machine-readable storage medium of claim 10, wherein the first gateway is a serving gateway including a bearer binding and event reporting function.

18. The non-transitory machine-readable storage medium of claim 10, wherein the session linking status of a message is indicated by a default value of the Session-Linking-Indicator AVP.
